(19) United States
(12) Patent Application Publication
(10) Pub. No.: US 2006/0136651 A1
(43) Pub. Date: Jun. 22, 2006

(54) Selectively-switchable bus connecting device for chip device

(75) Inventors: Chang-Cheng Yap, Hsin Chu (TW); Chih-Fu Tsai, Hsin Chu (TW); Chien-Min Hsieh, Hsin Chu (TW)

Correspondence Address: EDWARDS & ANGELL, LLP, P.O. BOX 55874, BOSTON, MA, 02205, US

(73) Assignee: RDC Semiconductor Co., Ltd., Hsin Chu (TW)

(21) Appl. No.: 11/088,027

(22) Filed: Mar. 22, 2005

(30) Foreign Application Priority Data
Dec. 16, 2004 (TW) 093139096

(51) Int. Cl. G06F 13/00

(52) U.S. Cl. 710/316

(57) ABSTRACT

A selectively-switchable bus connecting device is proposed, which is designed for use in conjunction with a chip device for connecting the multiple signal lines of the chip device's internal bus in a user-specified mapping manner to the multiple signal lines of a socket on an external circuit board. This feature allows chip devices of the same type to be usable for mounting on different types of circuit boards having different socket signal line arrangements, with the benefits of flexible arrangements and cost-effective design and manufacture of circuit boards with chip devices.

### BACKGROUND OF THE INVENTION

1. Field of the Invention

This invention relates to computer hardware technology, and more particularly, to a selectively-switchable bus connecting device which is designed for use in conjunction with a chip device, for connecting the multiple bus signal lines of the chip device, such as PCI (Peripheral Component Interconnect) compliant bus signal lines, in a user-specified mapping manner to a corresponding set of variously-arranged bus signal lines of a socket on an external circuit board, which allows chip devices of the same type to be connectable to different types of circuit board sockets having different arrangements of bus signal lines.

2. Description of Related Art

PCI (Peripheral Component Interconnect) is a standard peripheral bus architecture that is widely utilized on computer platforms, such as desktop computers, notebook computers, network servers, and so on, for connecting the CPU (Central Processing Unit) of the computer platform externally to a circuit board for connection to various kinds of peripheral devices, such as monitor adapters, hard disk drives, CD-DVD drivers, network adapters, to name just a few, for the purpose of allowing the CPU to exchange data with these peripheral devices.

The PCI standard specifies a set of bus signals for a CPU to exchange data with peripheral devices. In practice, however, the PCI specification further includes some extensions, such as Mini PCI, which specifies the same set of bus signal lines in a different manner of arrangement on the circuit board socket, i.e., in a reversed order of arrangement. For example, the original PCI standard specifies a set of bus signals named AD0-AD31 and CBE0-CBE3, which are arranged on the circuit board socket in the order of [AD0-AD31, CBE0-CBE3]; whereas by the Mini PCI specification, the same set of bus signals are arranged in a reversed order, i.e., [AD31-AD0, CBE3-CBE0], on the circuit board socket.

Due to the above-mentioned case, one can try to layout two sets of pins on the same chip device to accommodate for the circuit board sockets having different pin sequences, however it increases design complexity and manufacturing cost of computer system board Another solution is to design two variations of chip devices having different pin arrangements so that they can be respectively coupled to a PCI-compliant circuit board socket and a Mini PCI compliant circuit board socket. One apparent drawback to this solution, however, is that the design and manufacture of two types of chip devices having the same functionality but different pin arrangements is also undoubtedly highly costly and inconvenient to implement.

### SUMMARY OF THE INVENTION

It is therefore an objective of this invention to provide a selectively-switchable bus connecting device for integration to a chip device to allow the same chip device to be selectively connectable to circuit board sockets having different pin arrangements (e.g. a PCI-compliant circuit board socket and a Mini PCI compliant circuit board socket) without having to simultaneously allocate different sets of pins on the chip device, so as to allow the manufacture of computer system boards to be more flexible in design and more convenient and cost-effective to implement.

The selectively-switchable bus connecting device according to the invention is designed for use in conjunction with a chip device for connecting the multiple bus signal lines of the chip device, such as PCI (Peripheral Component Interconnect) compliant bus signal lines, in a user-specified mapping manner to a corresponding set of variously-arranged bus signal lines of a socket on an external circuit board, which allows the chip device to be connectable to different types of circuit board sockets having different arrangements of bus signal lines.

### BRIEF DESCRIPTION OF DRAWINGS

The invention can be more fully understood by reading the following detailed description of the preferred embodiments, with reference made to the accompanying drawings, wherein:

FIG. 1A is a schematic diagram showing a first example of the application of the selectively-switchable bus connecting device according to the invention;

FIG. 1B is a schematic diagram showing a second example of the application of the selectively-switchable bus connecting device according to the invention;

FIG. 2 is a schematic diagram showing the internal architecture of the selectively-switchable bus connecting device according to the invention;

FIG. 3A is a schematic diagram showing another example of the application of the selectively-switchable bus connecting device according to the invention; and

FIG. 3B is a schematic diagram showing still another example of the application of the selectively-switchable bus connecting device according to the invention.

### DETAILED DESCRIPTION OF PREFERRED EMBODIMENTS

The selectively-switchable bus connecting device for chip device according to the invention is disclosed in full details by way of preferred embodiments in the following with reference to the accompanying drawings.

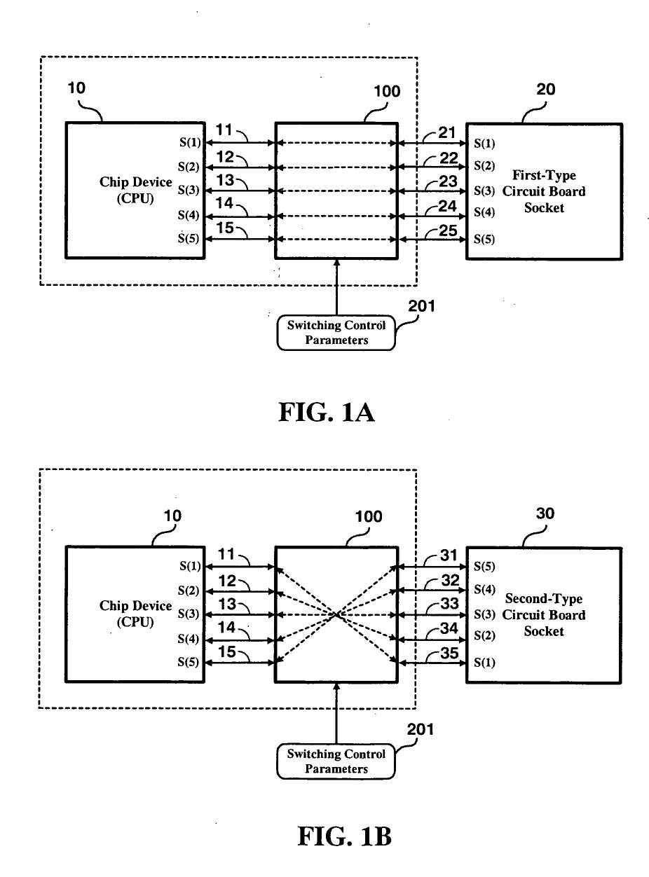

FIG. 1A and FIG. 1B are schematic diagrams used to depict two application examples of the selectively-switchable bus connecting device of the invention 100. As shown, the selectively-switchable bus connecting device of the invention 100 is designed for use in conjunction with a chip device 10, such as a CPU (Central Processing Unit) chip, for connecting the multiple bus signal lines 11, 12, 13, 14, 15 of the chip device's internal bus interface, such as an PCI (Peripheral Component Interconnect) compliant bus interface, selectively in a user-specified mapping manner to a corresponding set of bus signal lines 21, 22, 23, 24, 25 of a first-type circuit board socket 20 as shown in FIG. 1A, or to a corresponding set of variously-arranged bus signal lines 31, 32, 33, 34, 35 of a second-type circuit board socket 30 as shown in FIG. 1B. In the case of FIG. 1A, the internal bus signal lines 11, 12, 13, 14, 15 of the chip device 10 are respectively arranged in a prespecified order for the input/output of a set of bus signals [S(1), S(2), S(3), S(4), S(5)], and the signal lines 21, 22, 23, 24, 25 of the first-type circuit board socket 20 are also arranged in the same order as the internal bus signal lines 11, 12, 13, 14, 15 of the chip device 10 for the transfer of the signals [S(1), S(2), S(3), S(4), S(5)] (note that in FIG. 1A and the ensuing drawings, only 5 bus signal lines are illustrated for demonstrative purpose, but in practice, the number of bus signal lines may be up to dozens or hundreds, and may be labeled with different names, such as AD0-AD31 and CBE0-CBE3. In the case of FIG. 1A, the selectively-switchable bus connecting device of the invention 100 is capable of being controlled by an externally-input set of switching control parameters 201 to switch in such a manner as to connect the internal bus signal lines 11, 12, 13, 14, 15 of the chip device 10 respectively to the signal lines 21, 22, 23, 24, 25 of the first-type circuit board socket 20 (i.e., as shown in FIG. 1A, the signal line 11 is connected to the signal line 21, the signal line 12 is connected to the signal line 22, the signal line 13 is connected to the signal line 23, the signal line 14 is connected to the signal line 24, and the signal line 15 is connected to the signal line 25), so as to allow the signals [S(1), S(2), S(3), S(4), S(5)] to be exchangeable between the chip device 10 and the first-type circuit board socket 20 by way of the selectively-switchable bus connecting device of the invention 100.

In the case of FIG. 1B, the bus signal lines 31, 32, 33, 34, 35 of the second-type circuit board socket 30 are arranged in a different order from the internal bus signal lines 11, 12, 13, 14, 15 of the chip device 10, i.e., the signal lines 31, 32, 33, 34, 35 are arranged respectively for the transfer of the signals [S(5), S(4), S(3), S(2), S(1)] which is in a reversed order compared to the case of FIG. 1A. In this case, the selectively-switchable bus connecting device of the invention 100 is capable of being controlled by an externally-input set of switching control parameters 201 to switch in such a manner as to connect the internal bus signal lines 11, 12, 13, 14, 15 of the chip device 10 respectively to the signal lines 35, 34, 33, 32, 31 of the second-type circuit board socket 30 (i.e., as shown in FIG. 1B, the signal line 11 is connected to the signal line 35, the signal line 12 is connected to the signal line 34, the signal line 13 is connected to the signal line 33, the signal line 14 is connected to the signal line 32, and the signal line 15 is connected to the signal line 31), so as to allow the signals [S(1), S(2), S(3), S(4), S(5)] to be exchangeable between the chip device 10 and the second-type circuit board socket 30 by way of the selectively-switchable bus connecting device of the invention 100.

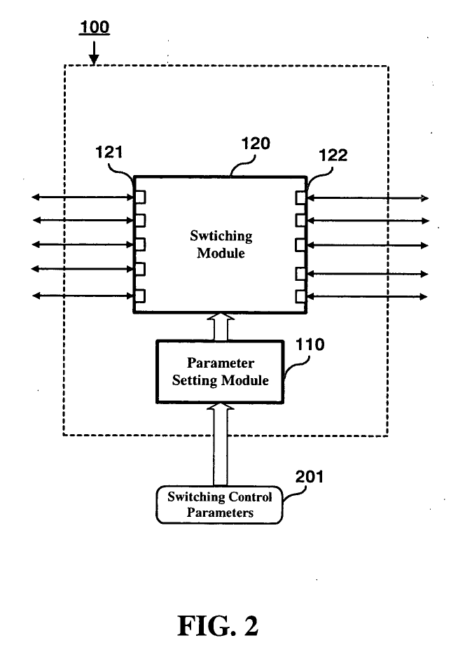

FIG. 2 is a schematic diagram showing the internal architecture of the selectively-switchable bus connecting device of the invention 100, which comprises: (a) a parameter setting module 110; and (b) a switching module 120. In practical implementation, for example, the selectively-switchable bus connecting device of the invention 100 can be realized by using a programmable logic circuit.

The parameter setting module 110 is used to specify a set of switching control parameters 201 to define a user-desired switching manner for the switched connections of the internal bus signal lines 11, 12, 13, 14, 15 of the chip device 10. The switching control parameters 201 can be specified by means of, for example, hardware reset straps, bonding selections, or software/firmware code, to name just a few. Moreover, the switching control parameters 201 can be either externally inputted to the selectively-switchable bus connecting device of the invention 100 as shown in FIG. 1A, or embedded in the internal circuitry of the chip device 10 and set through software control.

The switching module 120 is for example a programmable logic circuit, which has a first connecting side 121 and a second connecting side 122, wherein the first connecting side 121 has the same number of connecting points as the second connecting side 122. The switching module 120 is capable of being controlled by the switching control parameters 201 specified by the parameter setting module 110 to switch the connections between the multiple connecting points on the first connecting side 121 and the multiple connecting points on the second connecting side 122 in a user-desired mapping manner. In the example of FIG. 1A, the multiple connecting points on the first connecting side 121 are respectively connected to the internal bus signal lines 11, 12, 13, 14, 15 of the chip device 10, while the multiple connecting points on the second connecting side 122 are respectively connected to the bus signal lines 21, 22, 23, 24, 25 of the first-type circuit board socket 20; and in the example of FIG. 1B, the multiple connecting points on the first connecting side 121 are connected in the same manner, while the multiple connecting points on the second connecting side 122 are respectively connected to the bus signal lines 31, 32, 33, 34, 35 of the second-type circuit board socket 30.

Referring to FIGS. 1A-1B together with FIG. 2, in actual application, in the case of FIG. 1A where the chip device 10 and the first-type circuit board socket 20 have the same manner of signal arrangements, the hardware circuit designer needs to first utilize the parameter setting module 110 to specify a set of switching control parameters 201 for controlling the switching module 120 to perform a corresponding switching action to connect the internal bus signal lines 11, 12, 13, 14, 15 of the chip device 10 respectively to the signal lines 21, 22, 23, 24, 25 of the first-type circuit board socket 20 (i.e., the signal line 11 is connected to the signal line 21, the signal line 12 is connected to the signal line 22, the signal line 13 is connected to the signal line 23, the signal line 14 is connected to the signal line 24, and the signal line 15 is connected to the signal line 25), so as to allow the signals [S(1), S(2), S(3), S(4), S(5)] to be exchangeable between the chip device 10 and the first-type circuit board socket 20 by way of the selectively-switchable bus connecting device of the invention 100.

On the other hand, in the case of FIG. 1B where the chip device 10 and the second-type circuit board socket 30 have reversed signal arrangements, the hardware circuit designer needs first to utilize the parameter setting module 110 to specify a different set of switching control parameters 201 for controlling the switching module 120 to perform a corresponding switching action to connect the internal bus signal lines 11, 12, 13, 14, 15 of the chip device 10 respectively to the signal lines 35, 34, 33, 32, 31 of the second-type circuit board socket 30 (i.e., the signal line 11 is connected to the signal line 35, the signal line 12 is connected to the signal line 34, the signal line 13 is connected to the signal line 33, the signal line 14 is connected to the signal line 32, and the signal line 15 is connected to the signal line 31), so as to allow the signals [S(1), S(2), S(3), S(4), S(5)] to be exchangeable between the chip device 10 and the second-type circuit board socket 30 by way of the selectively switchable bus connecting device of the invention 100.

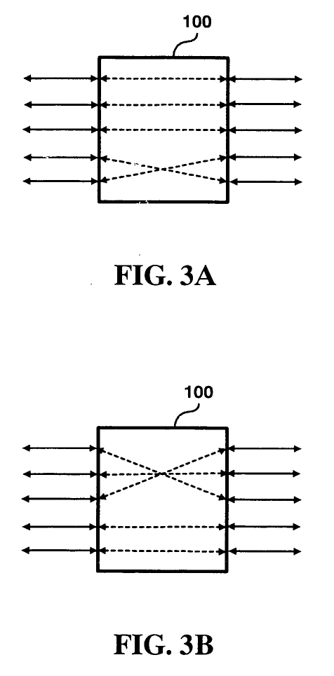

Broadly speaking, the selectively-switchable bus connecting device of the invention 100 is capable of switching the connections of a first group of signal connecting points in a user-specified mapping manner to a second group of signal connecting points. Beside the application examples shown in FIG. 1A and FIG. 1B, two more application examples are respectively illustrated in FIG. 3A and FIG. 3B.

In a practical application, for example, the selectively-switchable bus connecting device of the invention 100 can be utilized for connecting the internal bus signal lines of a PCI-compliant chip device having a bus signal assignment in the order [AD0-AD31, CBE0-CBE3] to the bus signal lines of an external circuit board socket having a bus signal assignment in the reverse order [AD31-AD0, CBE3-CBE0]. Beside the application on PCI-compliant bus architecture, however, the invention is also applicable to various other types of bus architectures for providing a selectively-switchable bus connecting function.

In conclusion, the invention provides a selectively-switchable bus connecting device for integration to a chip device, and which is characterized by the capability of selectively connecting the multiple bus signal lines of a chip device in a user-specified manner to the multiple bus signal lines of an external circuit board socket. This feature allows chip devices of the same type to be selectively connectable to either a PCI-compliant circuit board socket or a Mini PCI compliant one, without having to design two types of CPU chips having the same functionality but different pin arrangements, so as to allow the manufacture of computer system boards to be more flexible in design and more convenient and cost-effective to implement. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A selectively-switchable bus connecting device for use with a chip device having a set of bus signal lines for the purpose of connecting the bus signal lines of the chip device in a user-specified mapping manner to a corresponding set of variously-arranged bus signal lines of an external circuit board socket;
the selectively-switchable bus connecting device comprising:
a parameter setting module, which is used to specify a set of switching control parameters based on a user-specified mapping manner for the connections of the bus signal lines of the chip device to the bus signal lines of the external circuit board socket; and
a switching module, which is capable of being controlled by the switching control parameters specified by the parameter setting module to switch the connections of the bus signal lines of the chip device to the bus signal lines of the external circuit board socket in a user-specified mapping manner.

2. The selectively-switchable bus connecting device of claim 1, wherein the bus signal lines of the chip device is compliant with PCI (Peripheral Component Interconnect) standard.

3. The selectively-switchable bus connecting device of claim 1, wherein the bus signal lines of the external circuit board socket is compliant with Mini PCI standard.

4. The selectively-switchable bus connecting device of claim 1, wherein the switching control parameters are set by the parameter setting module by means of hardware reset straps.

5. The selectively-switchable bus connecting device of claim 1, wherein the switching control parameters are set by the parameter setting module by means of bonding selections.

6. The selectively-switchable bus connecting device of claim 1, wherein the switching control parameters are set by the parameter setting module by means of software/firmware code.

7. The selectively-switchable bus connecting device of claim 1, wherein the switching module is a programmable logic circuit.

8. The selectively-switchable bus connecting device of claim 1, wherein the switching control parameters are embedded in the internal circuitry of the chip device through software control.
